(19) United States
(12) Patent Application Publication
(10) Pub. No.: US 2012/0177388 A1
(43) Pub. Date: Jul. 12, 2012

(54) Fixing Device And Image Forming Apparatus Employing Same

(75) Inventors: Takahiro Imada, Kanagawa (JP); Masaaki Yoshikawa, Tokyo (JP); Kenji Ishii, Kanagawa (JP); Naoki Iwaya, Tokyo (JP); Takuya Seshita, Kanagawa (JP); Takamasa Hase, Tokyo (JP); Tetsuo Tokuda, Kanagawa (JP); Yoshiki Yamaguchi, Kanagawa (JP); Yutaka Ikebuchi, Kanagawa (JP); Toshihiko Shimokawa, Kanagawa (JP); Hiroshi Yoshinaga, Chiba (JP); Ippei Fujimoto, Kanagawa (JP)

(73) Assignee: RICOH COMPANY, LTD., Tokyo (JP)

(21) Appl. No.: 13/345,934

(22) Filed: Jan. 9, 2012

(30) Foreign Application Priority Data
Jan. 11, 2011 (JP) 2011-003350

(51) Int. Cl. G03G 15/20

(52) U.S. Cl. 399/33; 399/329

(57) ABSTRACT

A fixing device comprises a rotatable endless flexible belt, a drive roller opposed to the rotatable endless flexible belt to contact and drive an outer circumferential surface of the rotatable endless flexible belt, and a nip formation device receiving pressure from the drive roller via the rotatable endless flexible belt to form a nip thereon to sandwich and convey a recording sheet. A heat source is provided to generate heat and heat the nip. Each of the end roller portions of the drive roller has a higher friction coefficient surface than a central roller portion of the drive roller sandwiching the recording sheet. These end roller portions are composed of separate bodies from the central roller portion and detachably attachable from and to the central roller portion.

### CROSS-REFERENCE TO RELATED APPLICATION

This patent application is based on and claims priority pursuant to 35 U.S.C. §119 to Japanese Patent Application No. 2011-003350, filed on Jan. 11, 2011 in the Japanese Patent Office, the entire disclosure of which is hereby incorporated by reference herein.

### FIELD OF THE INVENTION

The present invention relates to a fixing device to fix a toner image onto a recording sheet, and an image forming apparatus, such as a photocopier, a facsimile, a printer, etc., incorporating the fixing device.

### BACKGROUND OF THE INVENTION

A fixing device that fixes a toner image onto a sheet of recording media (hereinafter “recording sheet) by applying heat and pressure onto an unfixed toner image on the recording sheet is widely used.

One such known fixing device is composed of a freely rotatable flexible endless belt, a driving and rotating roller pressing against an outer circumferential surface of the belt, a nip formation device pressing against the driving and rotating roller via the freely rotatable flexible endless belt to form a nip for transporting a recording sheet, and a heat source that heats such a belt or roller. For example, in Japanese Patent Application Publication Nos. 2008-165102 and 2009-104045 (JP-2008-165102-A and JP-2009-104045-A), a fixing system is described in which a recording sheet is sandwiched between a pressure belt and a fixing roller heated by a heat source and heats and melts (i.e., fix) the toner image onto the recording sheet. Further, in Japanese Patent Application Publication No. 2009-003410 (JP-2009-003410-A), a fixing system is described in which a recording sheet is sandwiched between a pressure roller and a fixing belt heated by a heat source and heats and melts (i.e., fix) the toner image onto the recording sheet.

In each of these fixing devices, the belt presses against the driven rotated roller via the belt. Therefore, it is desired that the belt is constantly driven and circulated by the roller to smoothly sandwich and convey the recording sheet in the nip formed between the roller and the belt.

Further, as described in JP-2008-165102-A, a pair of grip sections with a high friction coefficient is provided on both sides of a fixing belt and a pressure roller to serve as non-sheet passage portions. This configuration is employed to press the grip sections having the high friction coefficient against each other and obtain a sufficient gripping force therebetween to constantly drive the fixing belt. Further, JP-2009-104045-A discloses that a diameter of the grip section is greater than that of a central sheet passage portion of the pressure belt or the fixing roller. This configuration is employed to prevent the pressure belt and the fixing roller from separating from each other when a recording sheet passes therethrough and again obtain a sufficient gripping force therebetween to constantly drive the fixing belt.

However, in such a configuration, i.e., the grip section having the high friction coefficient is provided at both ends of the roller and the belt while the belt is driven by the roller, the grip deteriorates over time due to a decrease in a diameter of the grip section and a change in surface characteristics. Because of this, it is difficult for the roller to smoothly drive the belt, thereby eventually causing defective record sheet conveyance over time. The roller and the belt are designed to be replaceable, and in practice are replaced by determining its lifespan based on presumed deterioration of the grip section over time. By contrast, however, the central sheet passage portions of the belt and the roller are rarely degraded at that stage. As a result, with this replacement regimen, still good parts are replaced together with worn out ones, resulting in waste and unnecessary costs.

### BRIEF SUMMARY OF THE INVENTION

Accordingly, the present invention provides a novel fixing device that comprises a rotatable endless flexible belt, a drive roller opposed to the rotatable endless flexible belt to contact an outer circumferential surface of the rotatable endless flexible belt, and a nip formation device receiving pressure from the drive roller via the rotatable endless flexible belt to form a nip thereon to sandwich and convey a recording sheet. A heat source is provided to generate heat and heat the nip. Each of the end roller portions of the drive roller has a higher friction coefficient surface than a central roller portion thereof (sandwiching the recording sheet). These end roller portions are composed of separate bodies from the central roller portion and are detachably attachable from and to the central roller portion.

In another aspect, a surface of the central roller portion and a surface of each of the end roller portions of the drive roller are made of different material from the other.

In yet another aspect, the drive roller has an elastic layer exposed at its both end roller portions.

In yet another aspect, the central roller portion and the end roller portions of the roller have a different hardness on an axis from each other.

In yet another aspect, a width of each of the end roller portions of the drive roller is variable in an axial direction by replacing the end roller portions with the other end roller portions.

In yet another aspect, each of the end roller portions and the central roller portion of the drive roller has one of a chamfer, a U-shape, and a taper in the vicinity of the end surfaces.

In yet another aspect, a heat source is disposed on an inner circumferential surface side (within a loop of the rotatable endless flexible belt) to generate heat. A heat transfer member is provided an inner circumferential surface of the rotatable endless flexible belt to convey the heat to the rotatable endless flexible belt from the heat source. The nip formation device includes an engaging member placed on an inner circumferential surface side of the rotatable endless flexible belt which is pressed against and contacts the drive roller via the rotatable endless flexible belt. A supporter is provided to support the engaging member via the heat transfer member.

In yet another aspect, the engaging member engages the inner circumferential surface of the rotatable endless flexible belt via a sliding sheet.

In yet another aspect, one of the heat transfer member and the engaging member is coated with lubricant.

In yet another aspect, an image forming apparatus comprises an image formation section that forms an image on a recording sheet, and a fixing device that includes a rotatable endless flexible belt, a drive roller opposed to the rotatable endless flexible belt to contact an outer circumferential surface of the rotatable endless flexible belt, a nip formation device receiving pressure from the drive roller via the rotatable endless flexible belt to form a nip thereon to sandwich and convey a recording sheet, and a heat source to generate heat and heat the nip. Each of these end roller portions of the drive roller has a higher friction coefficient surface than a central roller portion thereof (sandwiching the recording sheet) and is composed of separate bodies from the central roller portion. Each of these end roller portions is detachably attachable from and to the central roller portion.

In yet another aspect, the fixing device is removably installable in image formation apparatus. A maintenance prompt is generated when image formation is executed a prescribed number of times after one of the fixing device as a whole and only the end roller portions of the fixing device is replaced.

In yet another aspect, a drive torque detector is provided to detect a drive torque of the fixing device. A maintenance prompt is generated when the drive torque detected by the drive torque detector falls outside a prescribed range.

### BRIEF DESCRIPTION OF THE DRAWINGS

A more complete appreciation of the present invention and many of the attendant advantages thereof will be more readily obtained as the same becomes better understood by reference to the following detailed description when considered in connection with the accompanying drawings, wherein:

FIG. 1 illustrates a schematic configuration of an image formation apparatus according to one embodiment of the present invention;

FIG. 2 illustrates a schematic configuration of a fixing device according to one embodiment of this invention;

FIG. 3 illustrates a fixing nip when viewed along a recording sheet conveyance direction;

FIGS. 4A to 4C collectively illustrate a configuration of a pressure roller having replaceable grips at both ends thereof;

FIGS. 5A and 5B are cross sectional views collectively illustrating one example of a layer configuration of the end grip section and the central roller portion of the pressure roller;

FIGS. 6A and 6B are cross sectional views collectively illustrating another example of a layering configuration of the end grip section and the central roller portion of the pressure roller;

FIG. 7 illustrates a configuration of the pressure roller having a grip with its width being variable in an axis direction at both ends;

FIG. 8 is an enlarged view illustrating an aspect in which the end grip section and a central end (of the pressure roller) is pressing against the fixing belt; and

FIG. 9 illustrates the end grip section and a central end (of the pressure roller) with their edges chamfered.

### DETAILED DESCRIPTION OF THE INVENTION

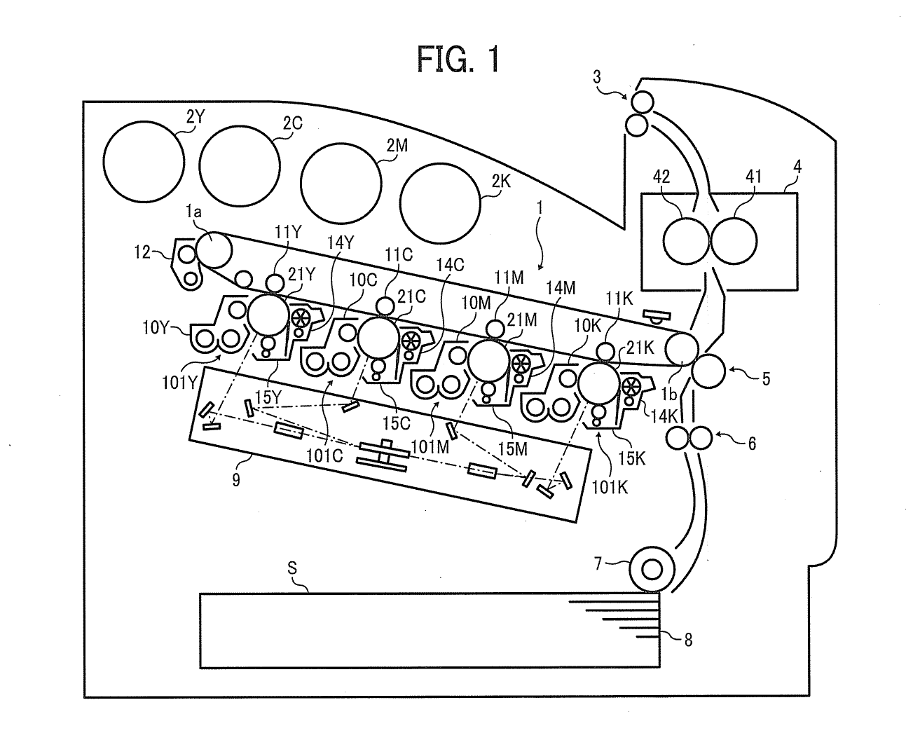

Referring now to the drawings, wherein like reference numerals designate identical or corresponding parts throughout the several views thereof, and in particular to FIGS. 1, a schematic configuration of an image formation apparatus is described according to one embodiment of the present invention. As shown, an image formation apparatus includes an intermediate transfer belt 1 as an intermediate transfer member serving as an image bearer on which a color toner image is formed from multiple color yellow (y), cyan(c), magenta (m), and black (k), and multiple toner bottles 2y, 2C, 2M, and 2K for supplying respective color toner particles for forming color toner images into an image formation apparatus body. The intermediate transfer belt 1 is freely rotatably suspended by a suspension roller 1a and intermediate transfer belt-driving roller 1b. The intermediate transfer belt 1 also circulates counterclockwise in the drawing as the intermediate transfer belt-driving roller 1b rotates counterclockwise in the drawing.

In the image forming apparatus, a recording sheet S stored in a sheet tray 8 loaded at a bottom section of the image formation apparatus main body is conveyed to a secondary transfer position opposed to the intermediate transfer belt 1 at a prescribed time, and a color toner image is transferred onto the recording sheet S. Subsequently, the color toner image is fixed onto the recording sheet S, and the recording sheet S is ejected from the top of the image forming apparatus after fixing. Specifically, from the bottom to the top of the image forming apparatus, there is provided a sheet feeding rollers 7 to feed a recording sheet S, a pair of registration rollers 6 to ensure transportation timing for a toner image transfer, a secondary transfer roller 5 which is opposed to the intermediate transfer belt-driving roller 1b and contacts the intermediate transfer belt 1 thereby forming a secondary transcriptional, a fixing device 4 that applies prescribed pressure and heat, and a pair of sheet exit rollers 3 that ejects the recording sheet outside. Thus, in a process of transporting through a carrier route formed by these rollers, a toner image transferred from the intermediate transfer belt 1 at the secondary transfer nip, and for recording sheet S, sequentially, and a toner image transferred onto the recording sheet S is fixed by the fixing device 4.

Multiple process cartridges 101c, M101, 101y, and 101k serving as color image formation sections each responsible for corresponding component color for forming a component color image are disposed diagonally inclined to a left upper side in the diagram along a longitudinal direction of the intermediate transfer belt 1. These image formation stations of the process cartridges 101y, 101c, 101m, and 101k have photoconductor drums 21Y, 21C, 21M, and 21K as image bears, respectively.

Further, each of the photoconductor drums 21Y, 21C, 21M, and 21K contacts each of the primary transfer rollers 11Y, 11C, 11M, and 11K via the intermediate transfer belt 1 by a prescribed pressure. Around the photoconductor drums 21Y, 21C, 21M, and 21K, dedicated charging devices 15Y, 15M, 15C, and 15K, and such developing devices 10Y, 10M, 10C, and 10K, such cleaning devices 14Y, 14M, 14C, and 14K for cleaning these photoconductors are provided, respectively.

Below the process cartridges 101y, 101c, 101m, and 101k, a writing unit 9 for writing a latent electrostatic image by exposing the surface of each of the photoreceptor drums 21Y, 21C, 21M, and 21K to a given laser light is located.

Further, beside the end of the intermediate transfer belt 1 in a longitudinal direction, a belt cleaning device 12 is provided opposite the suspension roller 1a via the intermediate transfer belt 1 for cleaning the intermediate transfer belt 1 by collecting residual toner remaining thereon.

The toner bottles 2y, 2C, 2M, and 2K, which supply toner to the developing devices 10Y, 10C, 10M, and 10K, are detachably located at an upper section in the image formation apparatus body from the left to the right in the drawing in order. These toner bottles 2Y, 2C, 2M, and 2K are filled up with yellow, cyan, magenta, and black toner articles, respectively. Each of the toner bottles 2Y, 2C, 2M, and 2K is connected to each of the color development devices 10Y, 10C, 10M, and 10K through a conveyance path to correspondingly supply each color toner thereto, so that a given amount thereof is replenished thereto.

In the image forming apparatus with such a configuration, a recording sheet S is fed by the sheet feeding roller 7 and is detected by a sensor, not shown, when the tip thereof reaches a pair of registration rollers 6. Subsequently, the pair of registration rollers 6 conveys the recording sheet S to a nip formed between a secondary transfer roller 5 and the intermediate transfer belt 1 at a prescribed time determined based on a detection signal. Thus, an image formed on the intermediate transfer belt 1 is transferred from the intermediate transfer belt 1 onto the recording sheet S.

The photoconductor drums 21Y, 21C, 21M, and 21K are previously uniformly charged by the charging devices 15Y, 15C, 15M, and 15K, and are then exposed to scanning of laser light emitted from the writing unit 9 based on image data, so that latent images are formed on the photoconductor drums 21Y, 21C, 21M, and 21K, respectively. As each of the electrostatic latent images is developed by each of the color development devices 10Y, 10C, 10M, and 10K, yellow, cyan, magenta, and black toner images are formed on the surfaces of the photosensitive drums 21Y, 21C, 21M, and 21K, respectively. Subsequently, a prescribed voltage is applied to the primary transfer rollers 11Y, 11C, 11M, and 11K, so that toner images borne on each of the photoconductor drums 21Y, 21M, and 21K are transferred onto the intermediate transfer belt 1. At that moment, image formation of each color is executed at a different time deviated from upstream toward downstream in a conveyance direction of the intermediate transfer belt 1, so that the toner images are transferred and superimposed onto the same position of the intermediate transfer belt 1. The toner image formed on the intermediate transfer belt 1 is transported to the secondary transfer position opposed to a secondary transfer roller 5 and is transferred onto the recording sheet S. The recording sheet S with the color image thus transferred is then transported to a fixing device 4, and the toner image is fused thereon by pressure and heat. Subsequently, the recording sheet S is ejected outside by a pair of exit rollers 3.

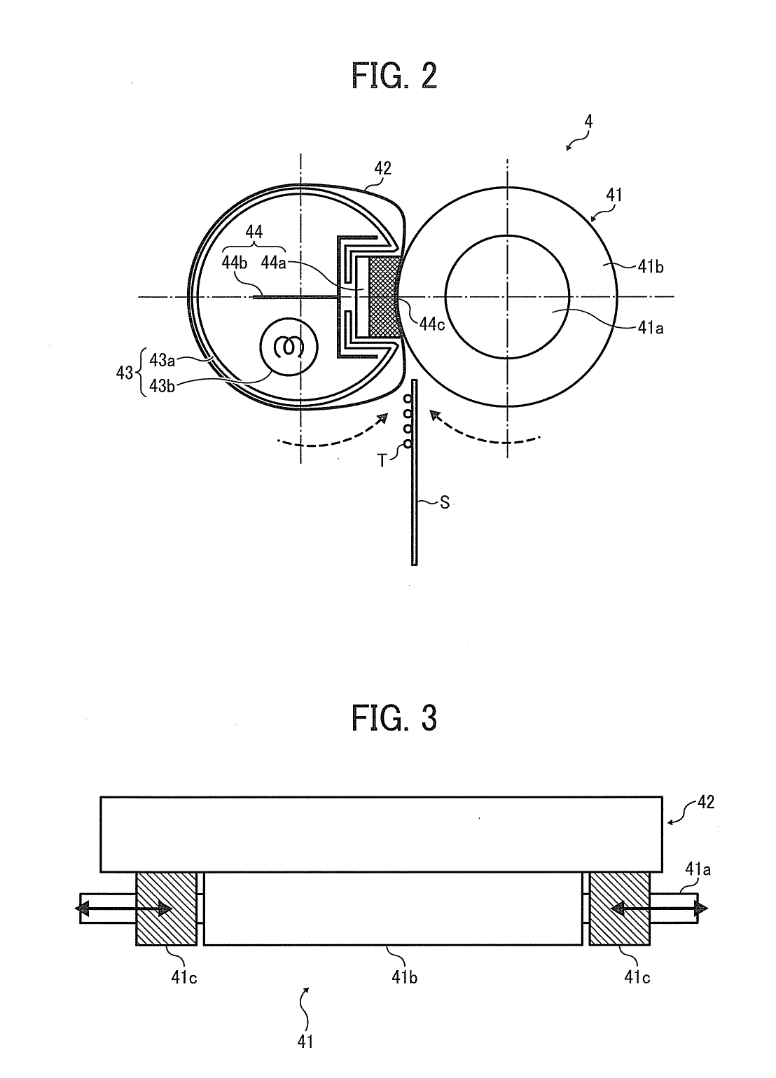

FIG. 2 shows an enlarged view of the fixing device 4. A pressure roller 41 driven and rotated as a pressure member and a fixing belt serving as an endless fixing member are provided in the fixing device 4. Further provided in a loop of the fixing belt 42 are a heating device 43 and a nip formation device 44.

The heating device 43 is composed of a metal pipe 43a and a heater 43b serving as a heat source heating the metal pipe 43a. The metal pipe 43a is made of nickel or stainless steel (SUS). An outer circumferential surface of the metal pipe 43a contacts the fixing belt 42, and the contacting surface thereof is coated with fluorine lubricant. The metal pipe 43a is directly opposed to an inner circumferential surface of the fixing belt 42 other than the fixing nip. The metal pipe 43a has a concaved portion concaved inside at the fixing nip thereby forming an opening therein. An engaging member 44a is inserted into the opening of the metal pipe 43a with a prescribed clearance as a nip formation device 44. A support stay 44b is also inserted in the opening as a nip formation device 44. Both side edges of the metal pipe 43a are secured to side plates of the fixing device 4, respectively.

The heater (i.e., a heat source) 43b employs a halogen heater or a carbon heater, and is secured to the side plates of fixing device 4 at its both side edges, respectively. The metal pipe 43a is thus heated by radiant heat generated by the heater 43b, while an output of which is controlled by a power source of the apparatus body. Further, the fixing belt 42 is entirely heated by the metal pipe 43a except for the nip, and the heat is applied to a toner image T borne on the recording sheet S from the surface of the fixing belt 42. An output of the heater 43b is controlled based on a detection result of a temperature sensor, such as a thermistor, etc., provided opposite the surface of the fixing belt 42. With such an output control of the heater 43b, temperature of the fixing belt 42 (i.e., fixing temperature) can be set to a desired level.

In this embodiment of the fixing device 4, since a portion of the fixing belt 42 in not only local heated, but almost all over the fixing belt 42 is heated in a circumferential direction by the metal pipe 43a, the fixing belt 42 can be fully heated preventing defective fixing even when the fixing device 4 operates at a higher speed. Further, since the heating device 43 is relatively simple as including the heater 43b and the metal pipe 43a, and can effectively heat the fixing belt 42, a warm-up time and a fast print time period can be miniaturized downsizing a system.

The fixing belt 42 is either a metal type made of such as nickel, stainless steel (SUS), etc., or an endless belt or film type made of such as polyimide resin, etc. The surface of the fixing belt 42 includes a mold releasing layer, such as a PFA layer, a PTFE layer, etc., thereby having mold releasing performance so that toner does not stick thereto. Further, the fixing belt 42 may preferably contact the outer circumferential surface of the metal pipe 43a almost without a gap therebetween. Consequently, a sliding area between the metal pipe 43a and the fixing belt 42 increases, so that a problem of accelerated wear of the fixing belt 42 can be suppressed. Further, a problem in that the metal pipe 43a excessively separates from the fixing belt 42 and accordingly heating efficiency of the fixing belt 42 decreases can be suppressed. Yet further, since the metal pipe 43a is disposed near the flexible fixing belt 42 and the fixing belt 42 can remain circular posture somewhat, the fixing belt 42 can reduce damage and degradation generally caused by the deformation thereof.

Further, a backside surface layer made of material containing fluorine can be formed on an inner circumferential surface of the fixing belt 42 to reduce a frictional resistance between an outer circumferential surface of the metal pipe 43a and the inner circumferential surface of the fixing belt 42. Further, although the metal pipe 43a has a circular cross-sectional shape in this embodiment, the cross-section can be polygon.

The nip formation device includes a support stay 44b as a supporter supported by the fixing device 4 and an engaging member 44a contacting the pressure roller 41 through the fixing belt 42. The support stay 44b reinforces and supports the engaging member 44a forming a nip, and is secured on an inner circumferential surface side of the fixing belt 42. The support stay 44b has a length equivalent to that of the engaging member 44a in a widthwise direction (hereinafter referred to as a main scanning direction) of the recording sheet S, and the both ends thereof in the main scanning direction are fixed and supported by the side plates of the fixing device 4, respectively. To satisfy the above-described function, the support stay 44b is preferably made of metal, such as stainless steel, iron, etc., having a great mechanical strength. An insulation member can be wholly or partially attached to a surface of the supporting stay 44b opposed to the heater 43b. Otherwise, the surface of the supporting stay 44b can be subjected to BA processing or specular polishing processing. Hence, because heat traveling from the heater 43b to the support stay 44b (i.e., heat heating the support stay 44b) is also used for heating the metal pipe 43a, efficiency of heating the fixing belt 42 (i.e., the metal pipe 43a) can be more improved.

Further, the engaging member 44a can be formed from a fluorine rubber wrapped around by a lubricant sheet, such as a PTEF sheet, etc. Further, the contact surface 44c contacting the pressure roller 41 via fixing belt 42 is formed in a concaved state when viewed in its axial direction along a curvature of the pressure roller 41. Consequently, since recording sheet S is sent from a fixing nip along the curvature of the pressure roller 41, a problem in that the recording sheet S is attracted after a fixing process and does not separate from the fixing belt 42 can be suppressed. Further, it can be good if the engaging member 44a is flat when viewed from the axial direction. With this configuration, a shape of the fixing nip almost becomes parallel to an image surface of the recording sheet S and improves a contact performance of the fixing belt 42 to the recording sheet S, so that a fixing performance is upgraded. Further, due to increase in curvature of the fixing belt 42 on the exit side of the fixing nip, the recording sheet S can easily be separated from the fixing belt 42 through the fixing nip. Further, since the engaging member 44a is configured by the elastic member, fine irregularities on a toner image borne of the recording sheet S can be followed in the fixing nip and a good fixing image can be obtained. Further, since the lubricant sheet winds around it, a sliding resistance between the engaging member 44a and the fixing belt 42 is reduced.

The pressure roller 41 is composed of a metal roller as a core metal 41a and an elastic layer made of silicone rubber bonded to the outer surface of the core metal 41a. The pressure roller 41 is pressed against the fixing belt 42 by a spring, not shown, and presses against the fixing belt 42, so that the engaging member 44a is crushed and transforms to have a given nip-width in the fixing nip.

The pressure roller 41 rotates upon receiving a driving force from a driving device, not depicted, composed of a motor, a driving roller, and a gear or the like installed in the image forming apparatus. Thus, by controlling the driving device with a controller composed of a CPU and a memory or the like provided in the image formation apparatus, a process line speed as a rotation speed of the pressure rollers 41 can be freely changed at a given time.

The fixing belt 42 is driven by an external roller and thus rotates, and the pressure roller 41 is driven by the driving device and thus rotates in this embodiment. When a driving force travelers from the pressure roller 41 to the fixing belt 42 in the fixing nip, the fixing belt 42 circulates.

Further, in such a fixing device 4, when a power source switch of an image forming apparatus body is turned on, power is supplied to the heater 43b and the pressure roller 41 starts rotation-driving. Hence, the fixing belt 42 is also driven (circulated) by a friction force of the pressure roller 41. Subsequently, the record sheet S is fed from the sheet feeding section. Then, an unfixed color image is transferred onto the recording sheet S at a position of the secondary transfer roller 5. The recording sheet S bearing the unfixed color image T (toner image) is conveyed into the fixing nip between the fixing belt 42 and the pressure roller 41 pressing against each other. Subsequently, the toner image T is fused onto the surface of the recording sheet S by heat applied from the fixing belt 42 heated by the heater 43b via the metal pipe 43a and pressure applied from the pressure roller 41 via the pressure engaging member 44a reinforced by the stay 44b. Further, the fixing belt 42 decreasing its temperature due to fusing, the fixing 43b is heated again by the heater 43b. In the fixing device 4, the fixing belt 42 is pressed against the pressure roller 41 by the pressure member 44a and is driven and circulated by a reaction force (rotation) opposed to a friction force, which is caused when the pressure roller 41 is driven and rotated.

Accordingly, the fixing belt 42 is not driven and the record sheet S is not smoothly transported when the friction force caused when the pressure roller 41 rotates is weak.

Then, in this embodiment, a pair of end grip sections with a high friction coefficient are provided at the widthwise ends of the pressure roller 41 serving as non-sheet passage sections to intensify a friction occurring when the pressure roller 41 rotates, so that the fixing belt 42 is smoothly driven. FIG. 3 is a view of a fixing nip when viewed in a recording sheet transport direction. The pressure roller 41 includes a core metal 41a, a central roller portion 41b overlying the core metal 41a and serving as a sheet passage portion, and a pair of end grip sections 41c overlying the core metal 41a and serving as non-sheet passage portions. A width of the central roller portion 41b is slightly longer than the maximum sheet passage width in an axial direction. The end grip sections 41c are a different body than that of the central roller portion 41b and are detachably attached to the metal core 41a.

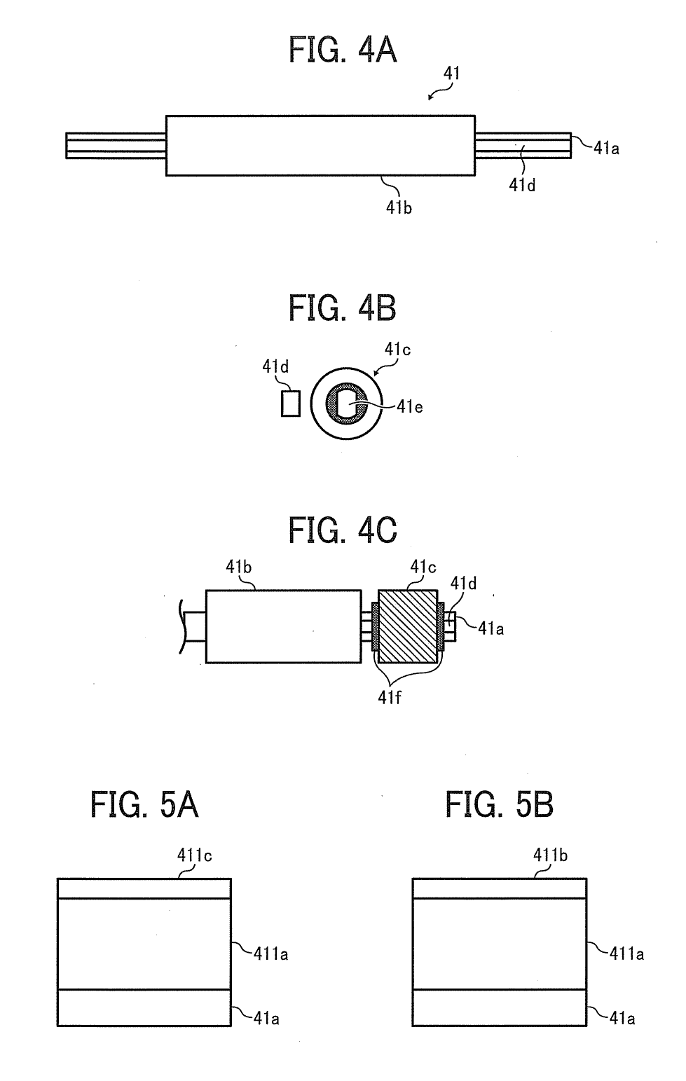

FIGS. 4A to 4C collectively describe one example of a configuration, in which the end grip sections 41c of the pressure roller 41 are replaceable. Especially, FIG. 4A is a breakdown chart illustrating the pressure roller 41 in an axial direction. As shown, an H-letter shape cut (i.e., an oval shape) 41d is provided to each of the ends of the metal core 41a to which the central roller portion 41b of the pressure roller 41 is bonded. Further, an H-letter shape cut (an oval shape) 41e is also provided to a hole 41e of the end grip section 41c, which is fit in by the metal core 41a as shown in FIG. 4B. The end grip sections 41c are secured in a circumferential direction by setting the hole around the metal core 41a. Further, as shown in FIG. 4C, it is desirous that positioning of the end grip section 41c in an axial direction thereof is executed using a securing member 41f, such as E or C ring, etc. With such a configuration, the end grip sections 41c are detachably attached to the central roller portion 41b, and only one or both of the end grip sections 41c of the pressure roller 41 can be replaced. For this reason, by replacing only the end grip sections 41c of the pressure roller 41 with a new one of a pair thereof when friction of one or both of the end grip sections 41c deteriorate over time, the fixing belt 42 can be driven smoothly.

FIG. 5 is a cross sectional view illustrating one example of a layer configuration of the central roller portion 41b and the end grip sections 41c of the pressure roller 41. Because the central roller portion 41b serves as a sheet passage portion, material of the surface has a good mold releasing characteristic. On the other hand, since the end grip sections 41c are non-sheet passage portions, and thus do not need the good mold releasing characteristics and are composed of high friction coefficient material to help to drive the fixing belt 42. For this reason, by employing a different surface layer between the central roller portion 41b and each of the end grip sections 41c, a function suitable for each site can be obtained. FIG. 5B is a layer configuration of the Central roller portion 41b as a sheet passage portion. The layer configuration includes the core metal 41a, an elastic layer 411a, and the mold releasing layer for exerting a mold releasing performance on the surface layer. As material of the mold releasing layer 411b, PFA (four fluoride ethylene parfluoroalkyl vinyl ester copolymer) as a fluorine resin or PTFE (four fluoride ethylene) resin can be used. On the other hand, FIG. 5A illustrates a layer configuration of the end grip sections 41c as non-sheet passage portions. The layer configuration includes the metal core 41a, the elastic layer 411a, and the high friction layer 411. The high friction layer 411c needs heat resistance due to contacting the fixing belt 42. However, a range of material and construction manners to be chosen was narrow in a conventional pressure roller, in which end grip sections and a center portion are integrated. According to one embodiment of the present invention, in which the end side grip sections 41 are different bodies, a degree of freedom of choosing material and construction manners increases. As a result, a simple construction manner can be adopted.

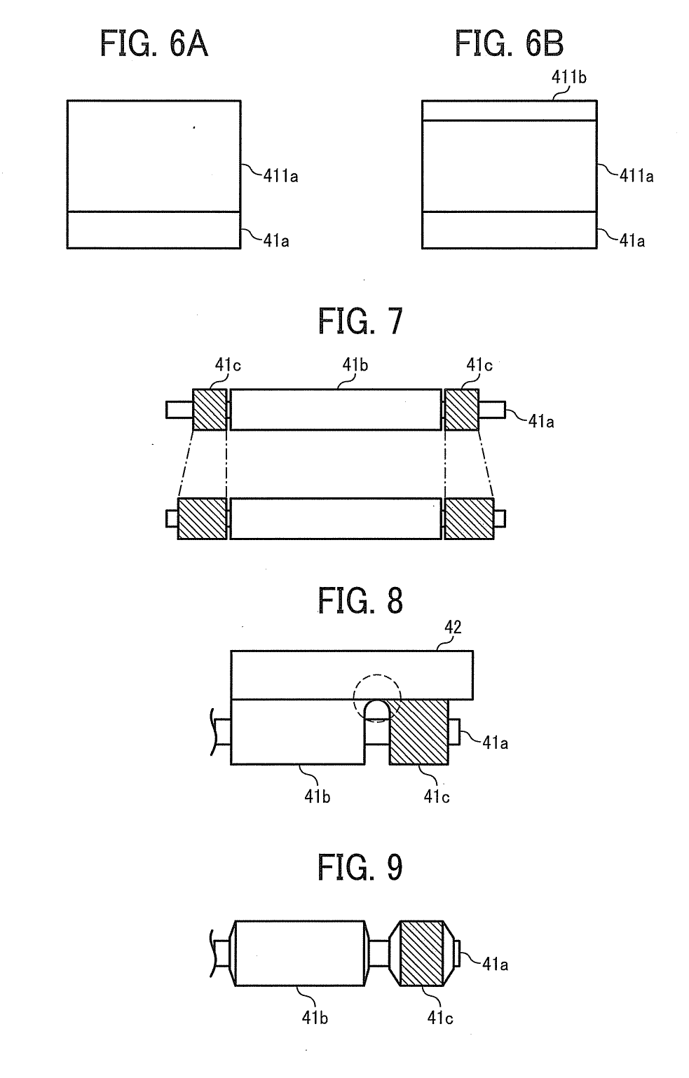

FIGS. 6A and 6B collectively show another example of a layer configuration of the end grip sections 41c and the central roller portion 41b of the pressurizing rollers 41. As shown in FIG. 6B, the layer configuration of the central roller portion 41b is substantially the same as that in FIG. 5B. On the other hand, the elastic layer 411a is exposed as a surface of the end grip section 41c to serve a high friction layer as shown in FIG. 6A. In this situation, by using silicone rubber as the elastic layer 411a preferably obtaining a high friction coefficient on the surface of each of the end grip Sections 41, sufficient driving force driving the fixing belt 42 can be obtained. Hence, the above-described configuration is simpler than that in FIG. 5, because a high friction layer is not separately equipped. Accordingly, cost of the end grip sections 41c and replacement parts can be reduced.

Further, hardness on an axis is differentiated between the end grip sections 41c and the central roller portion 41b of the pressure roller 41. This is because intensive friction is needed for the rotation drive pressure roller 41 to drive the fixing belt 42. Even in such a situation, however, the central roller portion 41b provides a friction to the fixing belt 42 through the recording sheet S during passage thereof, so that the friction to drive the fixing belt 42 is not sufficiently large at the time. By contrast, the end grip sections 41c can maintain a high friction because the record sheet S does not pass therethrough during passage thereof. Because of this, it is effective to apply a greater load on each of the end grip sections 41c to the driving fixing belt 42 even though total load applied in the axial direction is the same. Specifically, when hardness of each of the end grip sections 41c is higher, they can press against the fixing belt 42 more intensively, even if the end grip sections 41c are invaded by the same degree as the central roller portion 41b.

Whereas in a traditional pressure roller the central roller portion and the end grip section are integrated, it is difficult to differentiate hardness on the axis between the end grip section and the central roller portion. However, in an implementation like this embodiment in which each of the end grip sections 41c is different body, only hardness of each of the end grip section 41c can be increased. Hence, since a force is applied by the end grip sections 41c each having a higher coefficient of friction, intensive friction can be provided to the fixing belt 42. For example, to partially increase hardness on the axis, the thickness of the core metal is increased at the end grip sections 41c even though the elastic layer 411a is made of substantially the same material. Hence, by changing the hardness of the end grip sections 41c and the central roller portion on the axis and thereby changing the pressing force to press against the fixing belt 42 depending on positions along the axial direction when invaded by the fixing belt 42, a greater force is applied onto the end grip sections 41c and a belt-drive force can be effectively obtained when pressurized by the end grip sections 41c.

FIG. 7 shows a configuration of the end grip sections 41c with their widths in the axial direction being variable. For example, several different type pair of end grip members 41c having a different width from each other are prepared. Then, by replacing the end grip members 41c with another pair, a width of the grip section 41c is changed in the axial orientation. For example, depending on a deterioration level of the fixing belt 42 over time, an ordinary width of the end grip section 41c solely cannot obtain an enough force for driving the fixing belt 42 sometimes. Then, by replacing an end grip section 41c with a new one having a longer width, more intensive belt-driving force can be obtained dealing with the aging. More specifically, as far as the metal core 41a of the pressure roller 41 and the other parts can accommodate, a few end grip sections 41c having a different width from each other are prepared, while a groove permitting a securing member, such as an E or C ring, etc., to fit into is formed on the metal core 41a at prescribed positions corresponding to the widths of these end grip sections 41c.

FIG. 8 is an enlarged chart to explain an aspect in that a border between each of the end grip sections 41c and the central roller portion 41b is pressing against the fixing belt 42. As shown FIG. 8, when the end grip section 41c and the central roller portion 41b are closely positioned to each other, elastic layers protrude from those and possibly contact each other. Further, the elastic layer can heave almost at a middle portion in a height of the elastic layer between an interface of the metal core 41a and a surface layer thereof. Hence, when both of their edges of one of the end grip sections 41c and the central roller portion 41b contact in this way, these edges can be damaged.

Then, corner processing, such as chamfering, tapering, beveling, curving, etc., is preferably applied to both of the edges of the end grip section 41c and the central roller portion 41b. FIG. 9 is a diagram showing these one of end grip sections 41c and the central roller portion 41b with their edges being chamfered. With such corner processing, durability of the pressure roller 41 can be more enhanced by avoiding contact between these edges of the central roller portion 41b and the end grip section 41c in comparison with that having the edges without such processing.

Then, the fixing device 4 with the above-described configuration is normally used from a new product state, and warnings stating that it requires maintenance to foster replacement of the end grip sections 41c are displayed on a panel on image formation apparatus main body, when a prescribed number of sheets designated in advance is reached (i.e., the end grip sections 41c are supposed to be deteriorated at the time). Such warnings stating that it requires maintenance to foster replacement of the end grip section 41c are displayed on a panel on image formation apparatus main body, when another prescribed number of sheets designated in advance is reached (i.e., the end grip sections 41c are supposed to be deteriorated at the time) after the last replacement. Hence, the end grip sections 41c can always keep an enough friction during usage thereof. Because a service person executes replacement, warning on the display represents calling for the service person.

Warnings stating that it requires maintenance are displayed on a panel on image formation apparatus main body to foster replacement of the end grip section 41c, when a drive torque of the fixing device 4 falls outside a predetermined level. Specifically, due to deterioration of the end grip sections 41c over time, the torque of the fixing device 4 either rises or decreases. For example, when the end grip section 41c is degraded and the fixing belt 42 cannot be driven by the pressure roller 41 (i.e., the pressure roller 41 is idling), a friction coefficient of the end grip section 41c decreases, so that the fixing belt 42 rotate with a delay from the pressure roller 41 as a main drive. In such a situation, because a sliding friction caused by slipping between the fixing belt 42 and the end grip sections 41c is added to the drive torque, the drive torque becomes heavy as a result. Further, when the end grip sections 41c are more degraded, the fixing belt 42 does not circulate any more. During normal rotation, a sliding friction between an inner surface of the fixing belt 42 and the metal pipe 43a is included in the drive torque. However, in such a situation, a sliding friction disappears because the fixing belt 42 does not rotate, the torque decreases to the contrary. In other words, the torque indicates deterioration of the end grip sections 41c when it is too high or low. Thus, a torque detector (not shown) is preferably employed to detect a drive torque and provides a display to call for a service person when detection result does not falls between prescribed minimum and maximum torques to prompt an operator to deal a problem. Hence, the end grip sections 41c can always keep an enough friction during usage.

A torque of the fixing device 4 varies depending on a sheet thickness and a temperature condition. Because of this, the above-described determination is preferably executed by detecting a drive torque generated during rotation for a return operation, for example. Further, because a lot of variation is included immediately after start of rotation, a drive torque is desirably detected about five seconds after the start of rotation.

A torque of the fixing device 4 varies depending on a sheet thickness and a temperature condition. Because of this, the above-described determination is preferably executed by detecting a drive torque generated during rotation for a return operation, for example. Further, because a lot of variation is included immediately after start of rotation, a drive torque is desirably detected about five seconds after the start of rotation.

According to one aspect of the present invention, since the surface of the end grip section 41c serving as a non-sheet passage portion on the pressurized roller 41 has a high friction coefficient, the fixing belt 42 can receive a great gripping force from the pressure roller 41 and is driven constantly. According to another aspect of the present invention, even when a friction of the end grip section 41c is degraded due to aging, only the end grip section 41c of the pressure roller 41 needs to be replaced, and the pressure roller as a whole does not. According to yet another aspect of the present invention, the fixing belt 42 can be driven constantly even time elapses while reducing cost of replacement parts, because even though it is possible that an end of the fixing belt 42 is detachably attachable having a high friction coefficient, but is very difficult to realize such a configuration in comparison with a roller type and is costly. According to yet another aspect of the present invention, the central roller portion 41b and the end grip section 41c have different surfaces from each other. Thus, a function suitable for a portion can be obtained. According to yet another aspect of the present invention, since the elastic layer 411 of the end grip section 41c serves as a high friction layer and does not additionally employ the high friction layer, thus simplifying the configuration and thereby reducing costs. Further, cost of replacement parts can be further reduced. Further, according to the this embodiment, hardness is different between the pressure roller 41 end grip section 41c and 41b central axis. According to yet another aspect of the present invention, by changing the pressure against the fixing belt 42 depending on an axial position so that the end grip section 41c receives a greater force when the fixing belt 42 is invaded and pressurized, a belt-driven force can be effectively obtained. According to yet another aspect of the present invention, by increasing the width of the end grip section 41, more intensive belt-driving force can be obtained preferably accommodating degradation due to aging. According to yet another aspect of the present invention, contact between both ends of the end grip section 41c and the central roller portion 41b can be avoided more enhancing durability of the pressure roller 41 in comparison with a situation when both ends of the end grip section 41c and the central roller portion 41b are not subjected to such processing. According to yet another aspect of the present invention, the fixing belt 42 is not simply locally heated, but is almost entirely heated by the metal pipe 43a, thereby sufficiently heated preventing defective fixing, even if an apparatus is speeded up. According to yet another aspect of the present invention, a warm-up time period and a fast print time are minimized downsizing equipment. According to yet another aspect of the present invention, the sliding resistance between the engaging member 44a and the fixing belt 42 is reduced, and the fixing belt 42 appropriately circulates. According to yet another aspect of the present invention, the sliding resistance between the inner circumferential surface of the fixing belt 42 and the metal pipe 43a can be decreased, so that the fixing belt 42 can smoothly circulate. According to yet another aspect of the present invention, good fixing characteristic and a high-quality image are obtained. According to yet another aspect of the present invention, the end grip section 41c always keeps an enough friction, and accordingly the fixing belt 42 can always preferably be driven by the pressure Roller 41.

According to one embodiment of the present invention, a fixing device and an image formation apparatus capable of executing a stable fixing operation are provided at low cost by transporting a recording sheet between a drive roller and a pressure belt driven pressing against the drive roller.

Numerous additional modifications and variations of the present invention are possible in light of the above teachings. It is therefore to be understood that within the scope of the appended claims, the present invention may be practiced otherwise than as specifically described herein.

What is claimed is:

1. A fixing device comprising:
a rotatable endless flexible belt;
a drive roller disposed opposite the rotatable endless flexible belt to contact and drive an outer circumferential surface of the rotatable endless flexible belt, the drive roller having a central roller portion and two opposed end roller portions substantially contiguous to the central roller portion at both ends of the central roller portion and detachably attachable from and to the central roller portion, respectively, a surface of each of said two opposed end roller portions having a higher friction coefficient than a surface of the central roller portion of the drive roller;
a nip formation device disposed on a side of the rotatable flexible endless belt receiving pressure from the drive roller through the rotatable endless flexible belt to form a nip between the outer circumferential surface of the rotatable endless flexible belt and an outer circumferential surface of the drive roller to sandwich and convey a recording sheet; and
a heat source to heat the nip.

2. The fixing device as claimed in claim 1, wherein the surface of the central roller portion and the surface of each of said two opposed end roller portions of the drive roller are made of different material.

3. The fixing device as claimed in claim 1, wherein the drive roller further comprises elastic layers on the two opposed end roller portions of the drive roller, respectively.

4. The fixing device as claimed in claim 1, wherein the central roller portion and the two opposed end roller portions of the drive roller have different hardnesses.

5. The fixing device as claimed in claim 1, wherein the drive roller is configured to support another set of two opposed end roller portions around an axis at the both ends contiguous to the central roller portion, said another set of two opposed end roller portions having a different length in an axial direction from the two opposed end roller portions replaced.

6. The fixing device as claimed in claim 1, wherein neighboring lateral edges of the central roller portion and one of the two opposed end roller portions contiguous to the central roller portion of the drive roller have one of a chamfered edge, a U-shape, and a tapered edge.

7. The fixing device as claimed in claim 1, wherein the heat source is disposed within a loop of the rotatable endless flexible belt, the fixing device further comprising a heat transfer member opposed to the inner circumferential surface of the rotatable endless flexible belt to convey the heat from the heat source to the rotatable endless flexible belt,
said nip formation device comprising:
an engaging member placed on an inner circumferential surface side of the rotatable endless flexible belt being pressed against and contacting the drive roller through the rotatable endless flexible belt; and
a supporter to support the engaging member through the heat transfer member.

8. The fixing device as claimed in claim 7, further comprising a lubricated sheet interposed between said engaging member and the inner circumferential surface of the rotatable endless flexible belt.

9. The fixing device as claimed in claim 7, wherein one of said heat transfer member and the engaging member is coated with lubricant.

10. A fixing device comprising:
rotatable means;
means for contacting and driving an outer circumferential surface of the rotatable means, the contacting and driving means being disposed opposite the rotatable means and having a central portion and two opposed end portions substantially contiguous to the central portion at both ends of the central portion and detachably attachable from and to the central portion, a surface of each of said two opposed end portions having a higher friction coefficient than a surface of the central portion of the driving means;
means for forming a nip between the outer circumferential surface of the rotatable means and an outer circumferential surface of the driving means to sandwich and convey a recording sheet, said nip forming means being disposed on a side of the rotatable means receiving pressure from the driving means through the rotatable means; and
means for heating the nip.

11. The fixing device as claimed in claim 10, wherein the surface of the central portion and the surface of each of said two opposed end portions of the driving means are made of different material.

14. The fixing device as claimed in claim 10, wherein the driving means further comprises elastic layers on the two opposed end portions of the driving means, respectively.

15. The fixing device as claimed in claim 10, wherein the central portion and the two opposed end portions of the driving means have different hardnesses.

16. The fixing device as claimed in claim 10, wherein the driving means is configured to support another set of two opposed end portions around an axis at the both ends contiguous to the central portion, said another set of two opposed end portions having a different length in an axial direction from the two opposed end portions replaced.

17. An image fainting apparatus comprising:
an image formation section to form an image on a recording sheet; and
a fixing device including:
a rotatable endless flexible belt;
a drive roller disposed opposite the rotatable endless flexible belt to contact and drive an outer circumferential surface of the rotatable endless flexible belt, the drive roller having a central roller portion and two opposed end roller portions substantially contiguous to the central roller portion at both ends of the central roller portion and detachably attachable from and to the central roller portion, a surface of each of said two opposed end roller portions having a higher friction coefficient than a surface of the central roller portion of the drive roller;
a nip formation device disposed on a side of the rotatable flexible endless belt receiving pressure from the drive roller through the rotatable endless flexible belt to form a nip between the outer circumferential surface of the rotatable endless flexible belt and an outer circumferential surface of the drive roller to sandwich and convey a recording sheet; and
a heat source to heat the nip.

18. The image forming apparatus as claimed in claim 17,
wherein said fixing device is removably installable in image formation apparatus,
wherein a maintenance prompt is generated by the apparatus when image formation is executed a prescribed number of times after the fixing device as a whole is replaced.

19. The image forming apparatus as claimed in claim 17,
wherein a maintenance prompt is generated by the apparatus when image formation is executed a prescribed number of times after only the end roller portions of the fixing device are replaced.

20. The image forming apparatus as claimed in claim 17, further comprising:
a drive torque detector to detect a drive torque of the fixing device,
wherein a maintenance prompt is generated by the apparatus when the drive torque detected by the drive torque detector falls outside a prescribed range.
